(19) United States
(12) Patent Application Publication
(10) Pub. No.: US 2026/0291075 A1
(43) Pub. Date: Sep. 24, 2026

(54) ULTRA-WIDEBAND ANTENNAS AND RELATED ELECTROMAGNETIC STRUCTURES

(71) Applicant: The Charles Stark Draper Laboratory, Inc., Cambridge, MA (US)

(72) Inventors: Naftali Herscovici, Cambridge, MA (US); Sam Burke, Cambridge, MA (US); Azin Zarrasvand, Cambridge, MA (US)

(73) Assignee: The Charles Stark Draper Laboratory, Inc., Cambridge, MA (US)

(21) Appl. No.: 19/562,322

(22) Filed: Mar. 10, 2026

Related U.S. Application Data
(60) Provisional application No. 63/769,660, filed on Mar. 10, 2025.

(51) Int. Cl. H01Q 13/08; H01Q 19/06; H01Q 21/20

(52) U.S. Cl. CPC H01Q 13/085; H01Q 19/06; H01Q 21/205

(57) ABSTRACT

The present disclosure provides improved wideband antenna and electromagnetic coupling structures. Some aspects relate to a wideband antenna array that may be suitable for directional finding applications. Some aspects of the present disclosure relate to a wideband flattened lens antenna array. Some aspects relate to a wideband 3-dimensional (3D) loaded spiral antenna configuration. Some aspects relate to a wideband suspended stripline with improved impedance control. Some aspects relate to a wideband horn antenna having substantially constant beamwidth over its bandwidth.

### RELATED APPLICATIONS

This application claims the benefit under 35 U.S.C. § 119(e) of U.S. Provisional Patent Application Ser. No. 63/769,660, filed Mar. 10, 2025, under Attorney Docket No.: C1756.70050US00, and entitled, “ULTRA-WIDEBAND ANTENNAS AND RELATED ELECTROMAGNETIC STRUCTURES,” which is incorporated by reference herein in its entirety.

### BACKGROUND

Antennas are used to transmit and receive electromagnetic signals. Conventional wideband antenna systems operate over a wide range of frequencies, which allows multiple frequency bands to be supported simultaneously. Performance of wideband antenna systems is measured by whether their gain, transmission efficiency, and impedance matching meets performance standards set by a particular application.

### SUMMARY

Some aspects of the present disclosure relate to an antenna array, including: a plurality of tapered slot antennas; and a conductive reference plate supporting the plurality of tapered slot antennas, wherein the plurality of tapered slot antennas extend in different respective directions from a central axis of the conductive reference plate.

In some embodiments, the tapered slot antennas are spaced at equal angular intervals about the central axis.

In some embodiments, each of the tapered slot antennas has a conductor with a tapered edge oriented towards the conductive reference plate.

In some embodiments, the antenna array further includes a plurality of feed points having signal feeds respectively coupled to the conductors of the tapered slot antennas and reference feeds coupled to the conductive reference plate.

In some embodiments, the plurality of tapered slot antennas includes a first tapered slot antenna extending from the central axis in a first direction of the different respective directions and a first feed point of the plurality of feed points coupled to the conductor of the first tapered slot antenna, the plurality of tapered slot antennas further includes a second tapered slot antenna extending from the central axis in a second direction of the different respective directions and a second feed point of the plurality of feed points coupled to the conductor of the second tapered slot antenna, and the first feed point is spaced farther from the central axis in the first direction than the second feed point is spaced from the central axis in the second direction.

In some embodiments, the conductive reference plate includes a plurality of conductors having tapered edges oriented towards the tapered edges of the conductors of the tapered slot antennas.

In some embodiments, the antenna array further includes a conductive signal plate disposed parallel to the conductive reference plate and including the conductors of the plurality of tapered slot antennas.

In some embodiments, the plurality of tapered slot antennas are configured to operate over a bandwidth of at least 9:1.

In some embodiments, each of the plurality of tapered slot antennas includes a first conductor, a second conductor, and a dielectric rod, the first conductor has a tapered edge facing the second conductor, and the dielectric rod is between the tapered edge and the first conductor. Some aspects of the present disclosure relate to a directional finding system, including: the antenna array; and circuitry configured to transmit and receive radio-frequency (RF) signals via individual ones of the plurality of tapered slot antennas and to determine a direction of a detected target based on relative energy levels of RF signals received via the plurality of tapered slot antennas.

Some aspects of the present disclosure relate to a directional finding system, including: an antenna array including a feed region having a plurality of signal feeds and a plurality of tapered slot antennas electrically coupled to the plurality of signal feeds, respectively, and extending from the feed region in a plurality of respective directions; and circuitry configured to transmit and receive radio-frequency (RF) signals via individual ones of the plurality of tapered slot antennas and to determine a direction of a detected target based on relative energy levels of RF signals received via the plurality of tapered slot antennas.

In some embodiments, each of the plurality of tapered slot antennas includes a conductor and the antenna array further includes a conductive plate supporting the plurality of tapered slot antennas and including the conductors of the plurality of tapered slot antennas.

In some embodiments, each of the conductors includes a tapered edge.

In some embodiments, the tapered edges are oriented away from the conductive plate.

In some embodiments, each of the plurality of tapered slot antennas includes a conductor including a tapered edge; the antenna array further includes a conductive plate, and the tapered edges of the plurality of tapered slot antennas are oriented towards the conductive plate.

In some embodiments, the feed region further includes a plurality of reference feeds, the antenna array further includes a conductive signal plate and a conductive reference plate, each of the plurality of tapered slot antennas includes a signal conductor electrically coupled to a respective signal feed of the plurality of signal feeds and a reference conductor electrically coupled to a respective reference feed of the plurality of reference feeds, the conductive signal plate includes the plurality of signal feeds and the signal conductors of the plurality of tapered slot antennas, and the conductive reference plate includes the plurality of reference feeds and the reference conductors of the plurality of tapered slot antennas.

In some embodiments, each of the signal conductors of the plurality of tapered slot antennas has a tapered edge, each of the reference conductors of the plurality of tapered slot antennas has a tapered edge, the tapered edges of the signal conductors and the tapered edges of the reference conductors are oriented towards each other.

In some embodiments, the plurality of tapered slot antennas are configured to operate over a bandwidth of at least 9:1.

In some embodiments, each of the plurality of tapered slot antennas includes a first conductor, a second conductor, and a dielectric rod, the first conductor has a tapered edge facing the second conductor, and the dielectric rod is between the tapered edge and the first conductor.

In some embodiments, the plurality of tapered slot antennas includes a first tapered slot antenna extending from the feed region to a first distal point in a first direction of the respective directions and electrically coupled to a first signal feed point of the plurality of signal feed points, the plurality of tapered slot antennas further includes a second tapered slot antenna extending from the feed region to a second distal point in a second direction of the respective directions and electrically coupled to a second signal feed point of the plurality of signal feed points, and the first signal feed point is spaced farther from the first distal point in the first direction than the second feed point is spaced from the second distal point in the second direction.

In some embodiments, the multi-beam flat lens antenna array includes a dielectric lens having a first substantially planar surface and a second substantially planar surface opposite to the first surface; and an array of antenna elements on the first planar surface and configured to transmit and/or receive radio-frequency (RF) signals via the dielectric lens.

In some embodiments, each antenna element of the array of antenna elements is configured to transmit and/or receive RF signals in a different respective direction via the dielectric lens.

In some embodiments, the array of antenna elements includes a first antenna element configured to transmit and/or receive RF signals in a first direction of the different respective direction via the dielectric lens, wherein the first direction is between 40 degrees and 60 degrees with respect to a central focal axis of the dielectric lens.

In some embodiments, the multi-beam flat lens antenna array further includes: circuitry coupled to the array of antenna elements and configured to transmit and/or receive RF signals via the array of antenna elements using the dielectric lens.

In some embodiments, the multi-beam flat lens antenna array, further includes antenna selection circuitry configured to select antenna elements of the array of antenna elements to transmit and/or receive the RF signals via the dielectric lens.

In some embodiments, the dielectric lens has a distribution of effective dielectric constant such that a focal point of the dielectric lens is on the first planar surface.

In some embodiments, the dielectric lens includes an array of lens unit cells having dielectric material and conductive material, wherein an amount of the dielectric material and conductive material in each lens unit cells is configured to produce an effective dielectric constant of the lens unit cell, and wherein the effective dielectric constants of the array of lens unit cells are configured to position the focal point of the dielectric lens on the first planar surface.

In some embodiments, the effective dielectric constants of the array of lens unit cells are configured to produce less than a predetermined difference in effective dielectric constant between adjacent groups of lens unit cells of the array of lens unit cells.

### BRIEF DESCRIPTION OF DRAWINGS

Various aspects and embodiments will be described herein with reference to the following figures. It should be appreciated that the figures are not necessarily drawn to scale. Items appearing in multiple figures are indicated by the same or similar reference number in all the figures in which they appear.

FIG. 1 is a top view of an example antenna array, according to some embodiments.

FIG. 2A is a side view of an example tapered slot antenna on a conductive reference plate that may be included in the antenna array of FIG. 1, according to some embodiments.

FIG. 2B is a side view of an alternative example tapered slot antenna on a conductive reference plate that may be included in the antenna array of FIG. 1, according to some embodiments.

FIG. 3A is a perspective view of an example tapered slot antenna array having a conductive signal plate and a conductive reference plate, according to some embodiments.

FIG. 3B is a side view of the tapered slot antenna array of FIG. 3A, according to some embodiments.

FIG. 3C is a side view of a tapered slot antenna of the antenna array of FIG. 3A, according to some embodiments.

FIG. 4A is a graph of measured and simulated voltage standing wave ratio (VSWR) vs. frequency of the example tapered slot antenna array of FIG. 3A, according to some embodiments.

FIG. 4B is a graph of measured and simulated realized gain of the example tapered slot antenna array of FIG. 3A, according to some embodiments.

FIG. 5 is a graph of measured return loss and realized gain of the example tapered slot antenna array of FIG. 3A, according to some embodiments.

FIG. 6A is a side view of an example tapered slot antenna array including conductive signal and reference plates and dielectric rods, according to some embodiments.

FIG. 6B is a side view of a tapered slot antenna with a dielectric rod of the tapered slot antenna array of FIG. 6A, according to some embodiments.

FIG. 7A is a graph of measured VSWR of the tapered slot antenna array of FIG. 6A, according to some embodiments.

FIG. 7B is a graph of measured realized gain of the tapered slot antenna array of FIG. 6A, according to some embodiments.

FIG. 8A is a side view of an example multi-beam antenna system including a flattened lens assembly, according to some embodiments.

FIG. 8B is a front view of the dielectric lens of the multi-beam antenna system of FIG.

8A, according to some embodiments.

FIG. 9 is a perspective view of an example three-dimensional (3D) corrugated spiral antenna, according to some embodiments.

FIG. 10 is a perspective view of an example 3D helical spiral antenna, according to some embodiments.

FIG. 11 is a top view of an example two-dimensional (2D) meandering spiral antenna, according to some embodiments.

FIG. 12 is a top view of an example dual-polarized a spiral antenna, according to some embodiments.

FIG. 13 a perspective view of an example 90-degree hybrid coupler implementing striplines, according to some embodiments.

FIG. 14 is a Gamma chart for the hybrid coupler of FIG. 14, according to some embodiments.

FIG. 15 is a side view of a cross section of a communications system-on-chip including an antenna and example stripline structures, according to some embodiments.

FIG. 16 is a perspective view of an example horn antenna with a dielectric rod, according to some embodiments.

FIG. 17 is a graph of simulated return loss for the horn antenna of FIG. 17, according to some embodiments.

FIG. 18 is a circuit diagram of example transmit circuitry that may be included in an antenna system, according to some embodiments.

FIG. 19 is a circuit diagram of example receive circuitry that may be included in an antenna system, according to some embodiments.

FIG. 20 is a block diagram of an example computer system that may be configured to perform at least some operations described herein in connection with FIGS. 1-19, according to some embodiments.

The features and advantages of the present disclosure will become more apparent from the detailed description set forth below when taken in conjunction with the drawings. When describing embodiments in reference to the drawings, directional references (“above,” “below,” “top,” “bottom,” “left,” “right,” “horizontal,” “vertical,” etc.) may be used. Such references are intended merely as an aid to the reader viewing the drawings in a normal orientation. These directional references are not intended to describe a preferred or only orientation of features of an embodied device. A device may be embodied using other orientations.

### DETAILED DESCRIPTION

The present disclosure provides improved wideband antenna and electromagnetic coupling structures. Some aspects relate to a wideband antenna array that may be suitable for directional finding applications. Some aspects of the present disclosure relate to a wideband flattened lens antenna array. Some aspects relate to a wideband 3-dimensional (3D) loaded spiral antenna configuration. Some aspects relate to a wideband suspended stripline with improved impedance control. Some aspects relate to a wideband horn antenna having substantially constant beamwidth over its bandwidth.

### I. Directional-Finding Wideband Antenna Array

An aspect of the present disclosure provides an antenna array including tapered slot antennas extending in different respective directions from a central axis, which may have advantageous properties for directional finding applications. Another aspect of the present disclosure provides a directional finding system including an antenna array having tapered slot antennas extending from a feed region in different respective directions, and circuitry configured to determine a direction of a detected target based on relative energy levels of radio-frequency (RF) signals received via the tapered slot antennas.

The present disclosure recognizes that conventional wideband phased arrays are not well-suited to some applications such as directional finding. Directional finding may involve transmitting signals in different directions, receiving reflections of the transmitted signals from a target, and determining the direction to the target based on which transmission direction resulted in the highest reflected signal power. In such applications, it may be useful to transmit and receive signals over a wide range of scan angles with consistent, substantially symmetrical beams at each scan angle to allow for precise directional finding processing of received signals.

The inventors have recognized that conventional phased arrays are limited in bandwidth and scan angle. Phased array circuitry that operates over a large bandwidth is difficult to design and implement. Moreover, performance of the phased array tends to degrade at large scan angles relative to the array center. Moreover, even at scan angles where performance of conventional phased arrays is satisfactory, such arrays do not provide consistent, substantially symmetrical beams at each scan angle as may be useful for applications such as directional finding. For example, beam centers at each scan angle may vary significantly over the bandwidth of the array.

One conventional antenna element that has conventionally been used in wide bandwidth, rectangular phased arrays is a Vivaldi or tapered slot antenna. Vivaldi antennas are conventionally fed using a balanced or differential feed, in which balanced currents are fed to the two tapered conductors of the antenna. The present disclosure recognizes that a downside of tapered slot antennas is that large bandwidth is achieved by extending the tapered slot antennas over a long length, which results in a tall rather than low profile antenna array.

The present disclosure further recognizes that circular or substantially circular (e.g., elliptical) wideband antenna arrays provide an avenue to achieve a wide scan angle by having antenna elements in the array extending from a central axis in different respective directions, such as disposed at predetermined (e.g., regular) angular intervals about a circumferential perimeter of a circle or ellipse. For example, antenna elements of the array may transmit signals one (or more) at a time with substantially non-overlapping beams in the azimuth direction (e.g., along the circumferential perimeter of the array), and received signal power from each transmission may be compared to identify the range of azimuth locations where the target is located. Consistent beams at each (e.g., discrete) scan angle may be achieved by having a substantially symmetrical configuration in the azimuth plane (e.g., along the circumferential perimeter of the array) at each antenna element in the array. A circular antenna array may be implemented using a smaller form factor than a conventional phased array antenna, in part, by using fewer antenna elements per direction that may be discretely scanned. Further, since the antennas of the array extend in different respective directions, the antenna array may have a low profile even when tapered slot antennas are included and have long lengths.

Accordingly, some embodiments of the present disclosure provide wideband antenna arrays having tapered slot antennas supported by a conductive reference plate that extend in different respective directions from a central axis. In some embodiments, wideband antenna arrays may be configured to achieve consistent and substantially symmetrical beams at each scan angle, such as due to symmetry about the central axis of the antenna array. In some embodiments, the tapered slot antennas may have signal and reference conductors, with the conductive reference plate including the reference conductors and/or a conductive signal plate including the signal conductors. In some embodiments, signal and/or reference conductors may be integral with conductive plates that support the antenna array, which may produce a robust and easy to feed configuration.

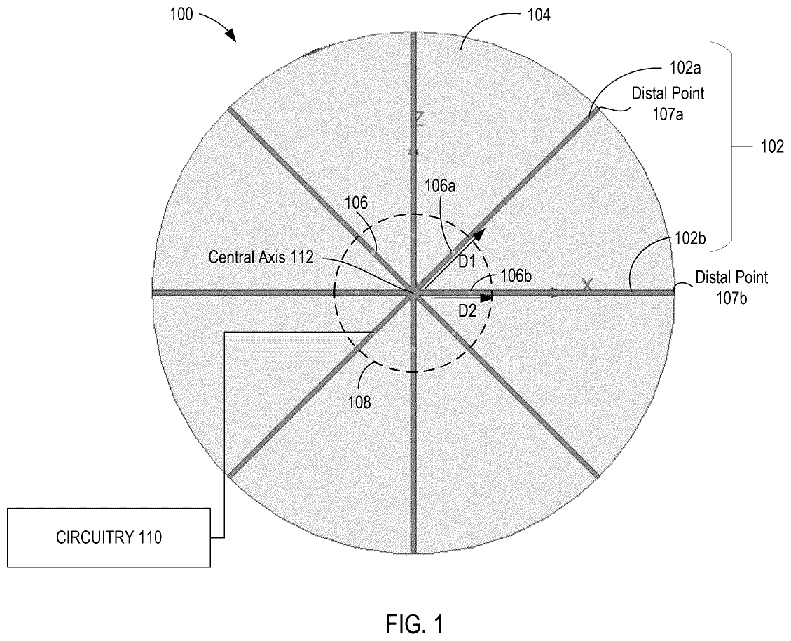

FIG. 1 is a top view of an example antenna array 100, according to some embodiments. In some embodiments, the antenna array 100 may be incorporated together with circuitry 110 into a directional finding system, such as described further herein.

In some embodiments, the antenna array 100 may include antennas 102 extending in different respective directions and supported by a conductive plate 104. For example, as shown in FIG. 1, the antenna array 100 has a central axis 112 and the antennas 102 extend in different respective directions from the central axis 112. For instance, in FIG. 1, a first antenna 102a extends from the central axis 112 in a first direction D1 and a second antenna 102b extends in a second direction D2 from the central axis 112. In the illustrated example, the first antenna 102a originates at the central axis 112 and extends in the first direction D1 to a first distal point 107a and the second antenna 102b originates at the central axis 112 and extends in the second direction to a second distal point 107b, though in other examples, antennas 102 need not originate at the central axis as they may be spaced from the central axis. In the illustrated example, the distal points 107a and 107b align with the outermost edge of the conductive plate 104, but the distal points may be inwardly or outwardly spaced from the outermost edge of the conductive plate in other examples.

In some embodiments, the antenna array 100 may be symmetrical about the central axis 112 in a plane of the conductive plate 104. For example, symmetry about the central axis 112 may facilitate symmetrical radiation patterns of the antennas 102 in the plane of the conductive plate 104 (e.g., azimuth plane), which may be advantageous in some directional finding applications. In some embodiments, the central axis may coincide with an effective phase center of the antenna array 100 in aggregate, but the present disclosure is not so limited. In the illustrated example, the central axis 112 is also a central axis of the conductive plate 104, but the present disclosure is not so limited.

In some embodiments, the antenna array 100 may be configured as a circular array, such as shown in FIG. 1, in which the conductive plate 104 may be circular. In other embodiments, the antenna array 100 may be configured as an elliptical array, in which the conductive plate 104 may be elliptical, depending on the implementation. In some embodiments, the antennas 102 may be spaced at equal angular intervals about the central axis 112. For example, in FIG. 1, the antenna array 100 includes 8 antennas 102 spaced from one another by 45 degrees about the central axis 112. It should be appreciated that any number of antennas may be included and angular intervals between antennas need not be equal, depending on the application.

In some embodiments, the antenna array 100 may include a plurality of feed points 106 in a feed region 108, which may be configured to feed the antennas 102, respectively. For example, each feed point 106 may be coupled to a respective antenna 102. As shown in FIG. 1, the first antenna 102a has a first feed point 106a and the second antenna 102b has a second feed point 106b. In some embodiments, each feed point 106 may include a signal feed point and a reference feed point, for example with the signal feed point coupled to a signal conductor of the respective antenna 102 and with the reference feed point coupled to a reference conductor of the respective antenna 102. For example, the signal feed point may be configured to feed (e.g., provide and/or obtain) a signal referenced with respect to ground at the reference feed point. Alternatively, the signal feed point may be configured to feed a first differential and/or balanced signal component and the reference feed point may be configured to feed a second differential and/or balanced signal component. It should be appreciated that the antennas 102 may be coupled to signal feed points but not reference feed points in some embodiments, such as where the antennas 102 are configured to radiate independently of coupling to a reference feed point.

In some embodiments, the antennas 102 may extend in different respective directions from the feed region 108. For example, in FIG. 1, the first antenna 102a extends from the feed region 108 in the first direction D1 and the second antenna 102b extends from the feed region 108 in the second direction D2. In the illustrated example, the central axis 112 of the antenna array 100 is also the central axis of the feed region 108, but the present disclosure is not so limited.

In some embodiments, the conductive plate 104 of the antenna array 100 may be configured as a conductive reference plate and/or a conductive signal plate. For example, a conductive reference plate may be configured to provide a ground plane for the antenna array 100. Alternatively or additionally, a conductive reference plate may include reference conductors of the antennas 102. In some embodiments, the feed points 106 may include reference feed points coupled to the conductive reference plate. Similarly, in some embodiments, a conductive signal plate may include signal conductors of the antennas 102. For example, the feed points 106 may include signal feed points coupled to the conductive signal plate.

In some embodiments, the antenna array 100 may be incorporated into a directional finding system with circuitry 110 coupled to the antenna array 100. For example, the circuitry 110 may be configured to transmit and receive RF signals via individual ones of the antennas 102 and to determine a direction of a detected target based on relative energy levels of RF signals received via the antennas 102. For instance, the circuitry may be configured to transmit an RF signal via the first antenna 102a and receive a reflection of the RF signal via the first antenna 102a. In some embodiments, the circuitry may be configured to transmit an RF signal via the first antenna 102a and receive reflections of the RF signal via multiple antennas 102, such as the first antenna 102a and the second antenna 102b.

In some embodiments, relative energy levels of RF signals received via the antennas 102 may indicate the direction of the detected target. For example, where a first RF signal is transmitted via the first antenna 102a, a reflection of the first RF signal is received via the first antenna 102a, a second RF signal is transmitted via the second antenna 102a, and a reflection of the second RF signal is received via the second antenna 102b, relative energy levels of the reflections of the first RF signal and the second RF signal may indicate the direction of the detected target. For instance, where the received reflection of the first RF signal has a greater energy level than the received reflection of the second RF signal, the detected target may be in a direction that is closer to the first direction D1 than to the second direction D2, and/or the direction may be precisely determined as angularly between the first direction D1 and the second direction D2 based on the difference in energy levels.

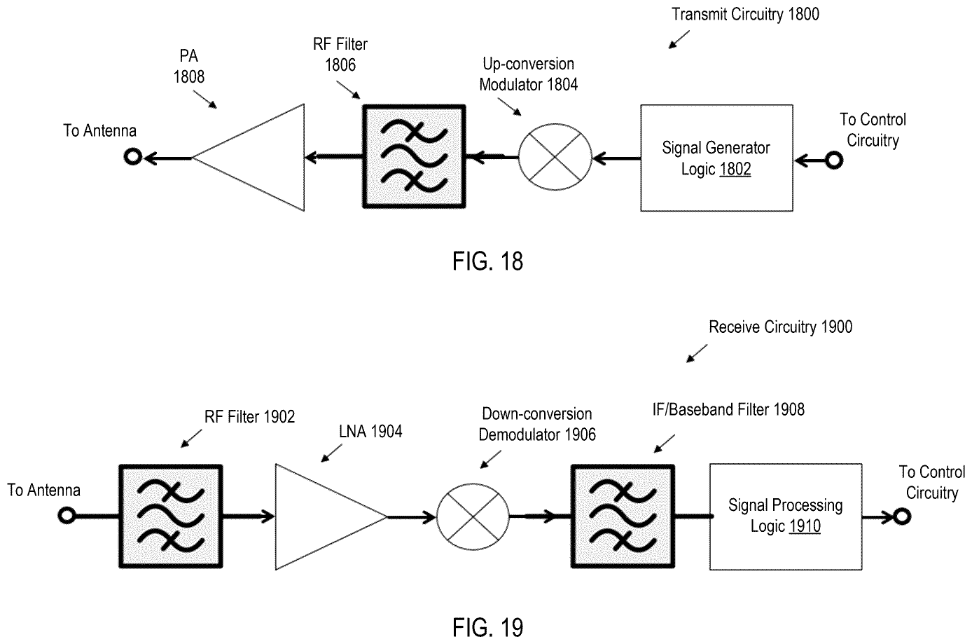

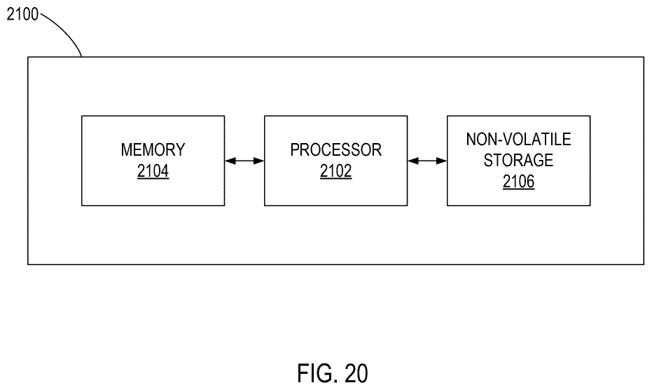

In some embodiments, circuitry 110 may include control circuitry, transmit circuitry, and/or receive circuitry. For example, the transmit circuitry may be configured to transmit RF signals via the antennas 102 and/or the receive circuitry may be configured to receive RF signals via the antennas 102. In some embodiments, transmit and/or receive circuitry may be configured as described herein including in connection with FIGS. 18-19, respectively. In some embodiments, the control circuitry may be configured to control transmission and/or reception of RF signals by the transmit and/or receive circuitry, and/or may be configured to determine a direction of a detected target. In some embodiments, the control circuitry may be configured as described herein including in connection with FIG. 20.

In some embodiments, the feed points 106 may be spaced at different distances from the central axis 112 and/or from the feed region 108. For example, the first feed point 106a may be spaced farther from the central axis 112 in the first direction D1 than the second feed point 106b is spaced from the central axis 112 in the second direction D2. For instance, offsetting the feed points 106 of the antennas 102 (e.g., adjacent first and second antennas 102a, 102b) may reduce undesired cross-coupling between the antennas 102 by displacing their phase centers. In other embodiments, such as shown in FIG. 1, the first feed point 106a and the second feed point 106b may be at equal distances from the central axis 112 in the respective first direction D1 and second direction D2. While FIG. 1 shows the feed points 106 at equal distances from the central axis 112 in the respective directions they extend, some of the feed points 106 may be at an equal distance from the central axis 112 while others of the feed points 106 may be at different distances from the central axis 112. For instance, each antenna 102 may have a feed point 106 that is offset in distance with respect to the central axis 112 from adjacent antennas 102, such that the feed point positions alternate between two (or more) positions with respect to the central axis 112.

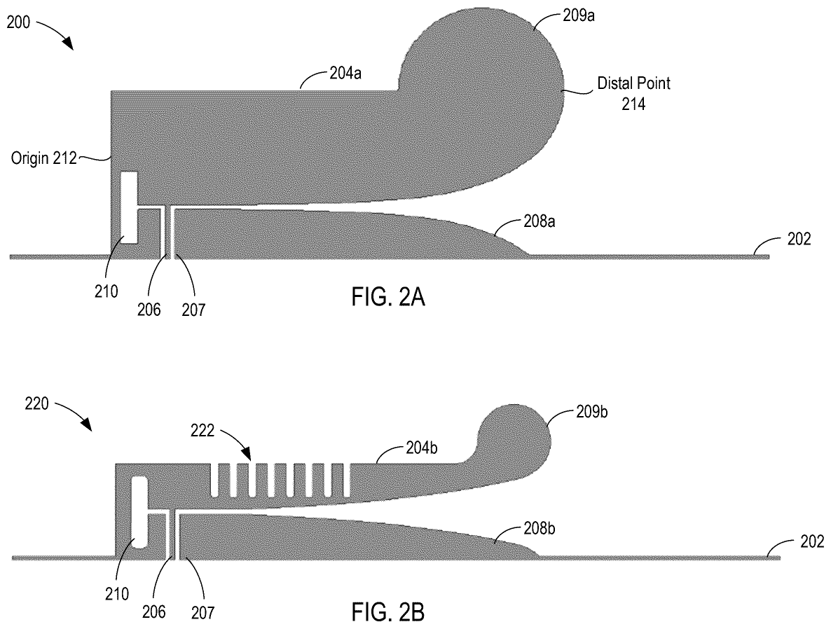

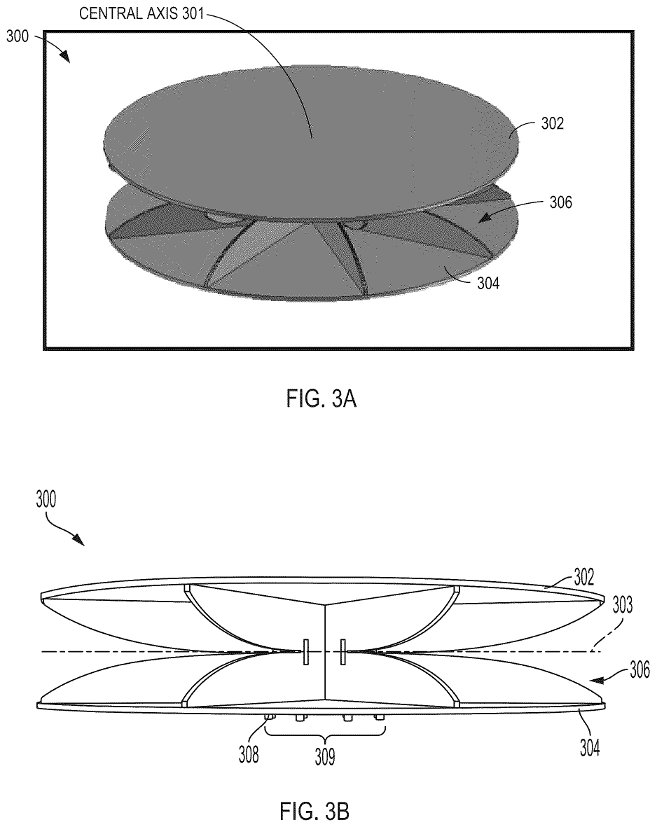

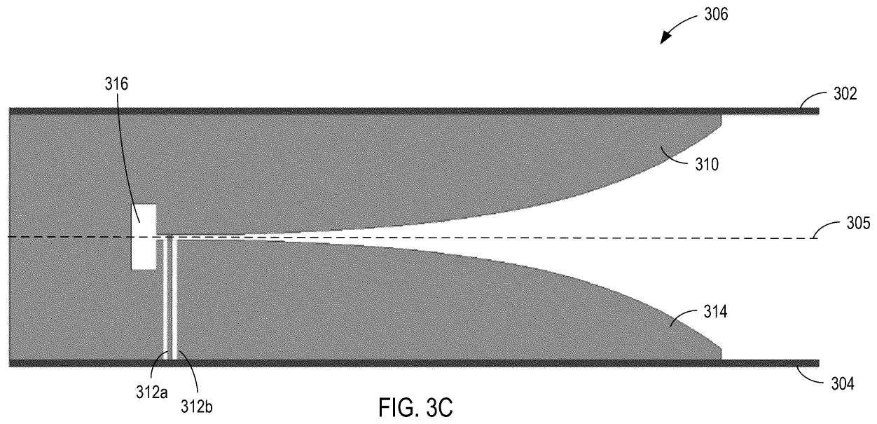

In some embodiments, the antennas 102 may be tapered slot antennas or Vivaldi antennas, which may advantageously provide wide bandwidth. For example, each of the antennas 102 may have a conductor with a tapered edge oriented towards the conductive plate 104. For instance, the conductor may be a signal conductor and the conductive plate 104 may be a conductive reference plate. Examples of tapered slot antennas having a signal conductor with a tapered edge oriented towards a conductive reference plate are shown in FIGS. 2A-2B, 3A-3C, and 6A-6B. Alternatively or additionally, the conductor may be a reference conductor and the conductive plate may be a conductive signal plate, which may further include a signal conductor having a tapered edge facing the tapered edge of the reference conductor. Examples of tapered slot antennas having a signal conductor with a tapered edge and a reference conductor with a tapered edge are shown in FIGS. 2A-2B and 3A-3C. It should be appreciated that other antenna geometries may be used depending on the application.

FIG. 2A is a side view of an example tapered slot antenna 200 on a conductive reference plate 202 that may be included in the antenna array 100 of FIG. 1. For example, the tapered slot antenna 200 is shown in FIG. 2A extending from an origin 212 to a distal point 214, which are offset from edges of the conductive reference plate 202 in the illustrated example.

In some embodiments, a tapered slot antenna 200 may include a conductor with a tapered edge oriented towards the conductive reference plate 202. For example, in FIG. 2A, the tapered slot antenna 200 includes a signal conductor 204a having a tapered edge oriented towards the conductive reference plate 202. In some embodiments, a tapered slot antenna 200 may include multiple conductors with tapered edges. For example, as shown in FIG. 2A, the tapered slot antenna 200 further includes a reference conductor 208a with a tapered edge oriented away from the conductive reference plate 202. For instance, in FIG. 2A, the tapered edge of the signal conductor 204a and the tapered edge of the reference conductors 208a are oriented towards each other.

In some embodiments, the conductive reference plate 202 may include the reference conductor 208a. For example, the reference conductor 208a may be integral with a planar portion of the conductive reference plate 202. For instance, the planar portion may extend beyond the reference conductor 208a, such as to further include reference conductors of additional tapered slot antennas 200 in the antenna array (e.g., 100). In other embodiments, the conductive reference plate may be electrically coupled to the reference conductor 208a by an interfacing connection, such as where the conductive reference plate 202 has an opening and the tapered slot antenna 200 may be installed in the opening.

In some embodiments, the signal conductor 204a may be configured for electrically coupling to a signal feed point (e.g., of a feed point 106) and/or the reference conductor 208a may be configured for electrically coupling to a reference feed point (e.g., of a feed point 106). For example, as shown in FIG. 2A, the signal conductor 204a includes a signal feed interface 206 that may be configured for electrically coupling to the signal feed point and the reference conductor 208a includes a reference feed interface 207 that may be configured for electrically coupling to the reference feed point. For instance, the feed point that includes the signal feed point and the reference feed point may include a coaxial connector, with the signal feed interface 206 may be configured to interface with the signal-carrying center conductor of the coaxial connector and the reference feed interface 207 configured to interface with the reference outer conductor of the coaxial connector. In other embodiments, a different feed configuration may be used, such as with a balun coupled to the signal feed interface and to the reference feed interface for coupling to the signal conductor 204a and reference conductor 208a, respectively.

In some embodiments, the reference feed interface 207 may be integral with a planar portion of the conductive reference plate 202. For example, the conductive reference plate 202 may have a coaxial connector mounted thereon, with an outer conductor of the coaxial connector electrically coupled to the conductive reference plate 202 and with a gap between the reference feed interface 207 and the signal feed interface 206, allowing the signal feed interface 206 to pass through the conductive reference plate 202 without short circuiting.

In some embodiments, the tapered slot antenna 200 may include an opening 210, which may be configured for tuning an impedance match of the tapered lot antenna. Similarly, as shown in FIG. 2A, the tapered slot antenna 200 may include a curved edge 209a oriented away from the conductive reference plate 202, which may be configured for further impedance tuning and/or radiating pattern control.

FIG. 2B is a side view of an alternative example tapered slot antenna 220 on a conductive reference plate that may be included in the circular antenna array of FIG. 1.

In some embodiments, the tapered slot antenna 220 may be configured as described herein for the tapered slot antenna 200 of FIG. 2A, such as having a signal conductor 204b and a reference conductor 208b. In some embodiments, the tapered slot antenna 220 may have a lower vertical profile than the tapered slot antenna 200.

In some embodiments, the signal conductor 204b of the tapered slot antenna 220 may include serrations 222, which may control edge diffraction in the radiating pattern of the antenna 220 at the expense of some operating bandwidth. For example, the serrations 222 may aid in sharpening the edges of the main beam of the radiating pattern in the elevation plane to counteract diffraction caused by the conductive reference plate 304, which may be beneficial for directional finding applications. In some embodiments, the signal conductor 204b may have a curved edge 209b with a smaller radius of curvature than the curved edge 209a of the signal conductor 204a.

FIG. 3A is a perspective view of an example tapered slot antenna array 300 having a conductive signal plate 302 and a conductive reference plate 304, according to some embodiments. FIG. 3B is a side view of the tapered slot antenna array 300 of FIG. 3A, according to some embodiments.

In some embodiments, the tapered slot antenna array 300 may be configured as described herein for the antenna array 100 including connection with FIG. 1. For example, as shown in FIGS. 3A and 3B, the tapered slot antenna array 300 may include tapered slot antennas 306 extending in multiple respective directions from a central axis 301 and/or feed region 309 of the tapered slot antenna array 300.

In some embodiments, the conductive reference plate 304 may be configured to support the tapered slot antennas 306. For example, the tapered slot antennas 306 may be mechanically and electrically coupled to the conductive reference plate 304. In the illustrated example, the conductive reference plate 304 includes reference conductors 314 (FIG. 3C) of the tapered slot antennas 306 that are integral with the conductive reference plate 304. In some embodiments, the conductive signal plate 302 may include signal conductors 310 (FIG. 3C) of the tapered slot antenna, which may be integral with the conductive signal plate 302. In some embodiments, the conductive signal plate 302 may be parallel to the conductive reference plate 304 with the tapered slot antennas 306 extending parallel to the plates 302, 304.

In some embodiments, the conductive reference plate 304 may be coupled to feed points 308, which may be coaxial connectors (e.g., 106) configured to electrically couple to the tapered slot antennas 306, such as described herein including in connection with FIG. 2A.

FIG. 3C is a side view of a tapered slot antenna 306 of the tapered slot antenna array 300 of FIG. 3A.

In some embodiments, the tapered slot antenna 306 may include a first conductor configured as a signal conductor 310 and a second conductor configured as a reference conductor 314. As described herein for the tapered slot antennas 200 and 220, the signal conductor 310 and the reference conductor 314 of the tapered slot antenna 306 may be separated from one another by a slot that is fed at a feed point 308 in the feed region 309 proximate the central axis 301 of the antenna array 300 (FIGS. 3A-3B). In some embodiments, the signal conductor 310 may be part of (e.g., integral with) the conductive signal plate 302 and the reference conductor 314 may be part of (e.g., integral with) the conductive reference plate 304.

In some embodiments, the tapered slot antenna 306 may be symmetrical with respect to an axis of extension 305 of the tapered slot antenna 306 that is perpendicular to the central axis 301 of the tapered slot antenna array 300. For example, the tapered slot antenna 306 may extend from the central axis 301 and/or the feed region 309 of the antenna array 300 along the axis of extension 305, for instance from an origin (e.g. 212) of the tapered slot antenna 306 to a distal point (e.g., 214) of the tapered slot antenna 306. In some embodiments, symmetry about the axis of extension 305 may facilitate a symmetrical radiation pattern of the tapered slot antenna 306 in a plane parallel to the central axis 301 that includes the axis of extension 305 (e.g., elevation plane). For instance, where the tapered slot antennas 306 of the antenna array 300 have symmetry with respect to their individual axes of extension, the antenna array 300 may have symmetry about a line of symmetry 303 (FIG. 3B) that runs along the circumferential perimeter of the antenna array and coincides with the slots of the tapered slot antennas 306. In some embodiments, symmetry about the line of symmetry 303 may facilitate symmetrical radiation patterns of the tapered slot antennas 306 in both azimuth and elevation planes, which may be advantageous for some directional finding applications.

In some embodiments, the signal conductor 310 may have a signal feed interface 312a configured for electrically coupling to a signal feed point of the feed points (e.g., 106) of the antenna array 300 and the reference conductor 314 may have a reference feed interface 312b of the feed points of the antenna array 300, such as described herein including in connection with the tapered slot antennas 200 and 220. In some embodiments, the signal conductor 310 and signal feed interface 312a may be part of (e.g., integral with) the conductive signal plate 302. In some embodiments, the conductive reference plate 304 may include (e.g., have integral therewith) the reference feed interface 312b and the reference conductor 314.

In some embodiments, the signal conductor 310 and the reference conductor 314 may have tapered edges that are oriented towards each other and towards the conductive reference plate 304 and the conductive signal plate 302, respectively, such as shown in FIG. 3C.

In some embodiments, the tapered slot antenna 306 may include an opening 316 which may be configured as described herein for the opening 210 of the tapered slot antenna 200 including in connection with FIG. 2A.

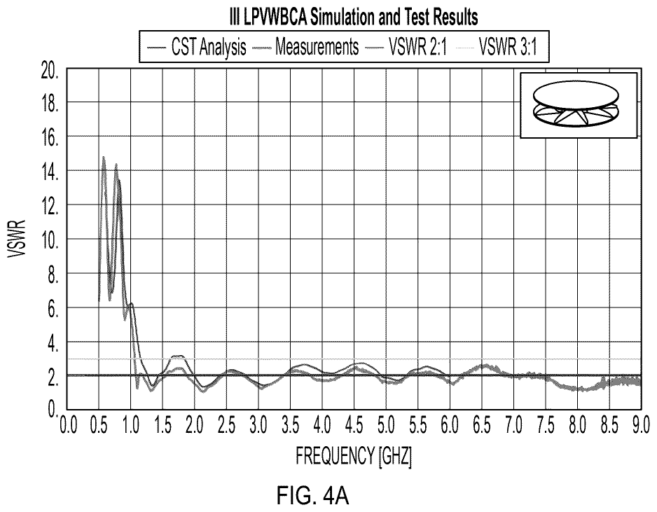

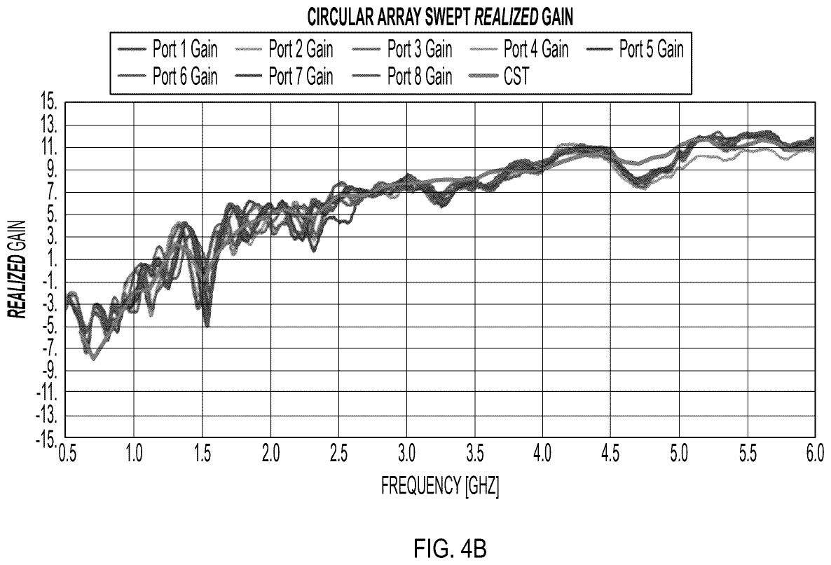

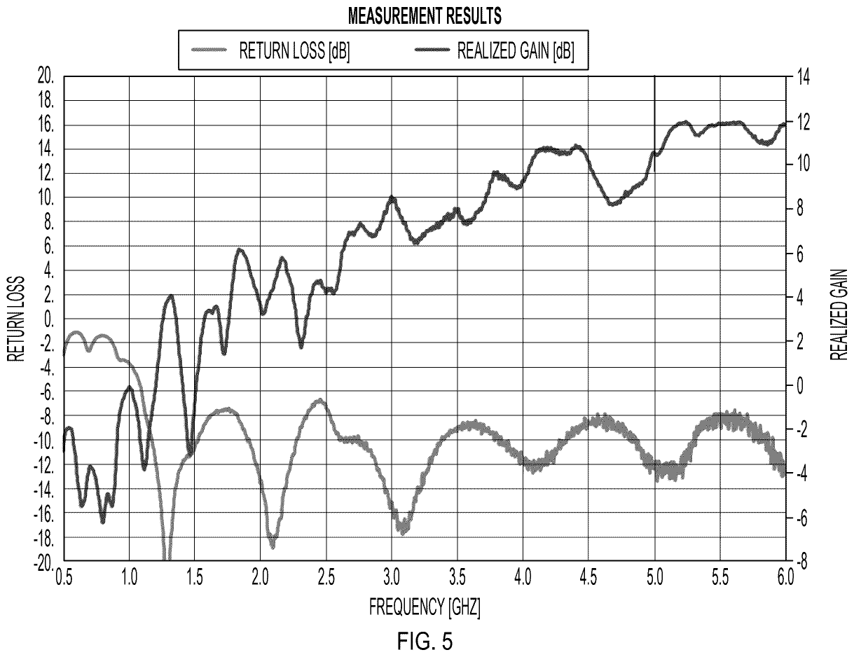

FIG. 4A is a graph of measured and simulated voltage standing wave ratio (VSWR) vs. frequency of the example tapered slot antenna array of FIG. 3A, according to some embodiments. FIG. 4B is a graph of measured and simulated realized gain of the example tapered slot antenna array of FIG. 3A, according to some embodiments. FIG. 5 is a graph of measured return loss and realized gain of the example tapered slot antenna array of FIG. 3A, according to some embodiments.

In some embodiments, the tapered slot antennas 306 may be configured to operate over a bandwidth of at least 9:1. For example, as shown in FIG. 4A, the tapered slot antennas 306 achieved a VSWR of less than 3 from 1 GHz to 9 GHz. And, as shown in FIG. 4B, realized gain for the 8 tapered slot antennas 306 was above −2 decibels (dB) over the same frequency range, indicating satisfactory transmission efficiency and consistency between the antennas 306. As shown in FIG. 5, a bandwidth of 6:1 may be achieved when taking return loss of the antennas 306 into account for realized gain, as is the case for some applications. Offsetting the feed points of the antennas 306, such as described in connection with FIG. 1, may further reduce mutual coupling to achieve greater realized gain over a larger bandwidth. It should be appreciated that the tapered slot antennas 306 may be configured to operate over a different frequency range than measured and simulated, such as by scaling the dimensions of the antennas to support a lower or higher range of frequencies having at least the same bandwidth.

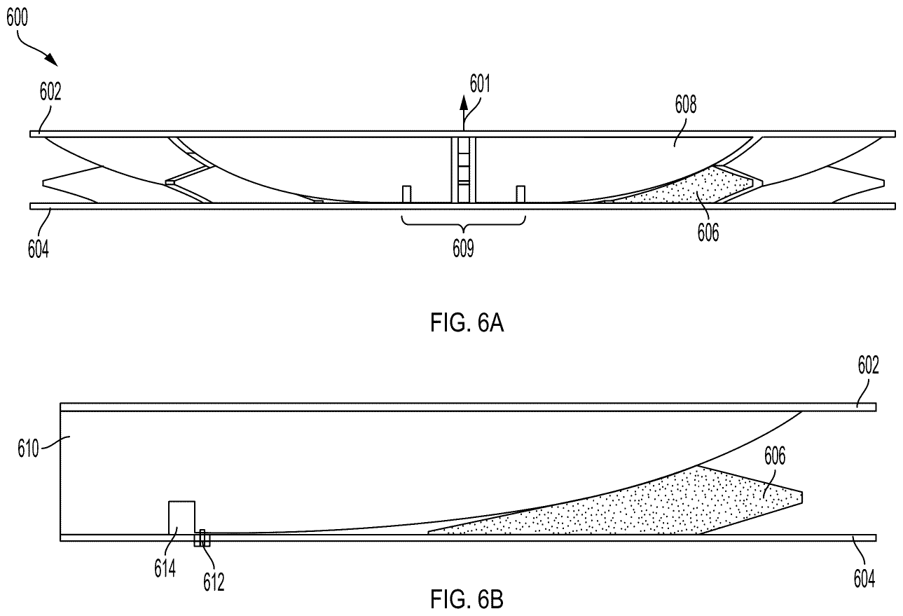

FIG. 6A is a side view of an example tapered slot antenna array 600 including a conductive signal plate 602 and a reference plate 604 and further including dielectric rods 606, according to some embodiments. FIG. 6B is a side view of a tapered slot antenna 608 with a dielectric rod of the circular tapered slot antenna array 600 of FIG. 6A.

In some embodiments, the tapered slot antenna array 600 may be configured as described herein for the antenna array 100 including in connection with FIG. 1 and/or as described herein for the tapered slot antenna array 300 including in connection with FIGS. 3A-3C. For example, the tapered slot antenna array 60 may include tapered slot antennas 608 extending in different respective directions from a central axis 601 and/or feed region 609 of the antenna array 600.

In some embodiments, the tapered slot antennas 608 may include a signal conductor 610 having a tapered edge oriented toward the conductive reference plate 604, such as described herein for the tapered slot antennas 306. In the illustrated example, the reference conductor of the tapered slot antenna 608 is provided by a planar portion of the conductive reference plate 604, as the conductive reference plate 604 may be configured to provide a reflection plane electromagnetic image of the tapered edge of the signal conductor 610. In some embodiments, the tapered slot antenna 608 may have a low profile due to the planar portion of the conductive reference plate 604 coupling directly across the slot to the signal conductor 610 (e.g., without a tapered edge on the reference conductor).

In some embodiments, the tapered slot antenna 608 may further include a dielectric rod 606. For example, the dielectric rod 606 may be between the tapered edge of the signal conductor 610 and the reference conductor. In the illustrated example, the dielectric rod 606 is between the tapered edge of the signal conductor and the planar portion of the conductive reference plate 604. In some embodiments, the dielectric rod 606 may have a tapered body having a width that increases with increasing width of the slot between the signal conductor 610 and the reference conductor. In some embodiments, the dielectric rod 606 may have a planar shape that is parallel to a plane of the signal conductor 610.

In some embodiments, the dielectric rod 606 may be configured to sharpen edges of the radiating pattern of the tapered slot antenna 608 in the elevation plane to counteract some diffraction at edges of the radiating pattern in the elevation pattern due to the low profile of the antenna array 600, the conductive signal plate 602, the conductive reference plate 604, and omission of a tapered edge on the reference conductor opposite the signal conductor 610. For example, the dielectric rod 606 may be configured to concentrate current away from the conductive signal plate 602 and the conductive reference plate 604. In some embodiments, a polyethylene rod may be implemented as the dielectric rod 606.

In some embodiments, the signal conductor 610 may be electrically coupled to a feed point 612 of the antenna array 600, which may be configured as described herein for the feed points 106 including in connection with FIG. 1. For example, the feed point 612 may include a coaxial connector having a center signal conductor electrically coupled to the signal conductor 610 and a reference outer conductor electrically coupled to the conductive reference plate 604.

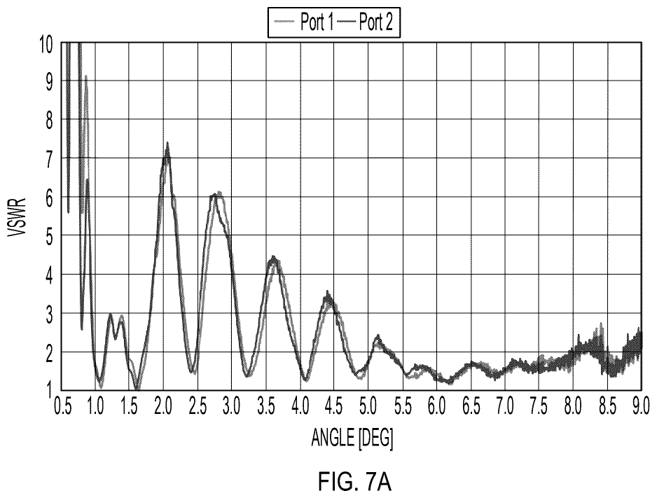

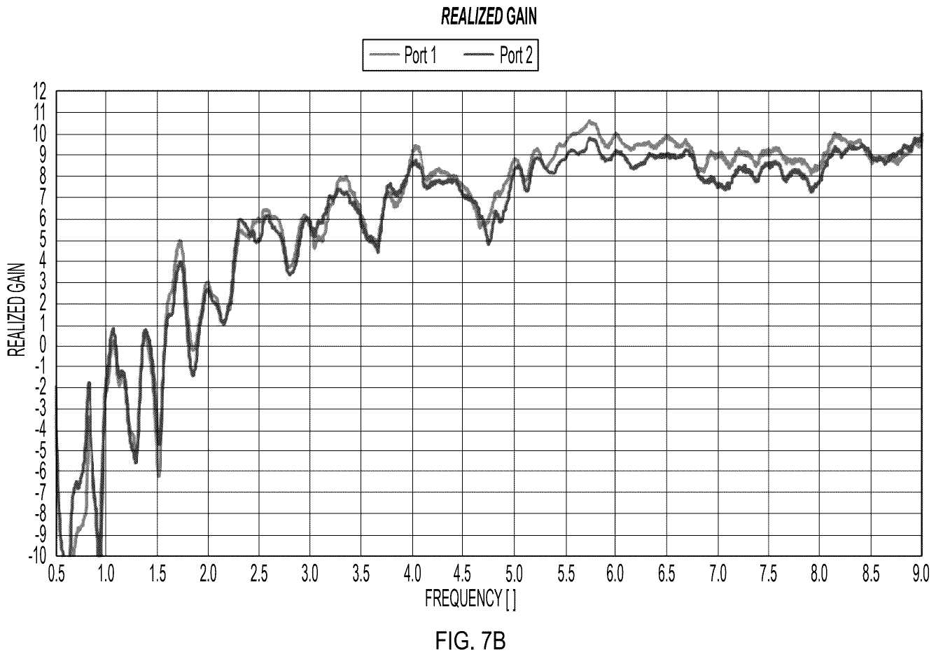

In some embodiments, the tapered slot antenna 608 may include an opening 614, which may be configured as described herein for the opening 210 including in connection with FIG. 2A FIG. 7A is a graph of measured VSWR vs. beam angle of the tapered slot antenna array of FIG. 6A, according to some embodiments. FIG. 7B is a graph of measured realized gain of the tapered slot antenna array of FIG. 6A, according to some embodiments.

In some embodiments, the tapered slot antenna array 600 may be configured to operate over a bandwidth of at least 9:1, such as described herein for the tapered slot antenna array 300. For example, as shown in FIG. 7B, realized gain for two of the tapered slot antennas 608 was comparable to the tapered slot antennas 306 despite the lower profile of the tapered slot antennas 608.

### II. Multi-Beam Flattened Lens Array

An aspect of the present disclosure provides a multi-beam flattened lens array including a flattened lens having a first surface configured to interface with an array of antenna elements and a second surface that is opposite and substantially parallel to the first surface. For example, the flattened lens may have a spatial distribution of effective dielectric constant within the flattened lens that locates the focal point of the flattened lens on the first surface, which facilitates placing the antenna elements substantially at the first surface for a low-profile implementation.

The present disclosure recognizes that beamforming has been performed using a phased array of antenna elements. In a phased array, antenna elements are fed with an applied phase shift on transmitted or received signals. Phase shifts can be applied in a pattern that causes the relative path lengths of signals transmitted or received by different antenna elements to resemble how the signals would be transmitted or received if the array were physically rotated in a given direction. The antenna elements may thus steer transmission or reception in a direction that depends on the particular phase shift applied.

The present disclosure recognizes that phased array systems can be implemented in a small form factor, but phase shifting is challenging to implement over a wide bandwidth. Moreover, phase shifters are typically required for every antenna element, which is expensive and complex to implement in a large array.

The present disclosure further recognizes that a multi-beam lens array has been used to achieve beamforming using an array of antenna elements distributed over a surface (e.g., spherical surface) of a lens. In a multi-beam lens array, electromagnetic waves that are transmitted or received by a given antenna element are focused in a particular direction based on the location of the antenna element on the surface of the lens. Typically, changes in dielectric constant in different regions within the lens will cause incident electromagnetic waves to be reflected or refracted in different directions, respectively. The dielectric profile of a lens can thus be designed to focus transmitted or received electromagnetic waves in a direction that corresponds to a given location on the lens where an antenna element may be located. Accordingly, an antenna element in the array may be selected to transmit or receive a signal in a given direction associated with that antenna element based on where it is located on the surface of the lens.

The present disclosure recognizes that multi-beam lens arrays do not require phase shifters to steer transmission or reception in different directions, but the lenses used (e.g., half-spherical lenses) are typically large and heavy, which makes them difficult to incorporate into a miniaturized system. Moreover, electromagnetic waves propagating in the dielectric material of the lens are subject to losses. While it is possible to replace a spherical lens with a dielectrically-equivalent flattened lens, the focal length of the lens may be large, and thus the antenna elements would need to be placed at a distance from the lens to comply with the long focal length of the lens. As a result, attempts to miniaturize a large lens by flattening it have been unsuccessful in meaningfully miniaturizing the system as a whole. Another challenge of implementing lens-based arrays is that performance degrades as the scan angle increases beyond, e.g., 40 degrees relative to the center of the outer surface of the lens.

To overcome the drawbacks of previous designs, the present disclosure provides a flattened lens and associated antenna system that achieves high performance over a wide range of scan angles with a low-profile implementation.

In some embodiments, a multi-beam flat lens antenna array described herein includes a dielectric lens having a first planar surface and a second planar surface that is opposite (e.g., substantially parallel to) the first planar surface. An array of antenna elements may be on the first planar surface and configured to transmit and/or receive RF signals via the dielectric lens. The dielectric lens may have a spatial distribution of effective dielectric constant within the lens that locates the focal point of the lens on the first planar surface. By having the focal point located on the first surface, little to no distance is required between the first planar surface and the array of antenna elements. For example, antenna elements may be implemented using an array of microstrips terminating at the first surface.

In some embodiments, the dielectric lens may include an array of lens unit cells, each lens unit cell including a dielectric material and conductive material (e.g., patterned with the dielectric material) such that the array of lens unit cells collectively provides the spatial distribution of effective dielectric constant that places the focal point on the first planar surface. In some embodiments, each lens unit cell may have an effective dielectric constant such that changes in effective dielectric constant between adjacent unit cells and/or between groups of lens unit cells in the array are less than a predetermined amount. By having less than a predetermined amount of change in effective dielectric constant between lens unit cells, high performance may be achieved over a large frequency range and over a wide range of scan angles as high as 60 degrees relative to the center of the first surface of the lens.

In some embodiments, lens unit cells may be patterned with pixels of conductive material that yield the spatial distribution of effective dielectric constant across the array of unit cells and that yield less than the predetermined amount of change in effective dielectric constant between unit cells. Using pixelized patterns of conductive material may allow a genetic algorithm to be implemented to optimize or substantially optimize the resulting spatial distribution of dielectric constant over the array and predetermined change in dielectric constant between unit cells.

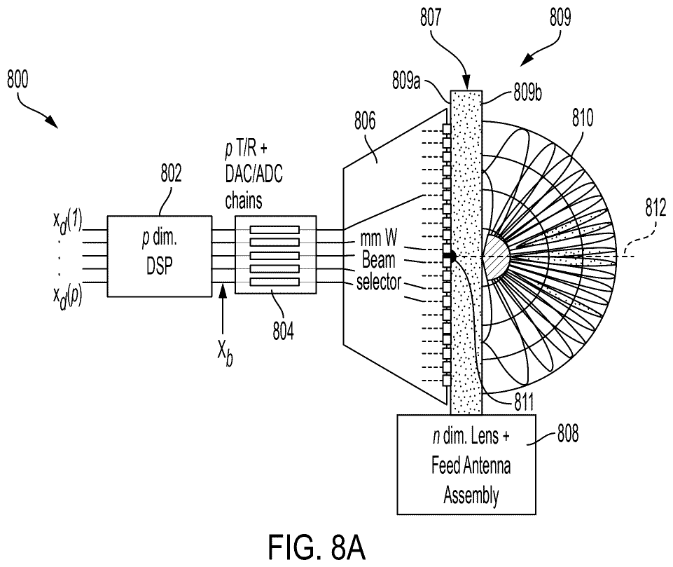

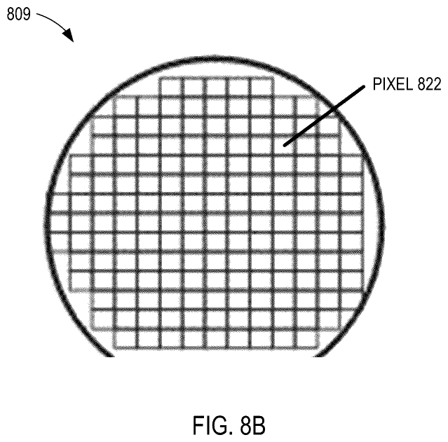

FIG. 8A is a side view of an example multi-beam antenna system 800 including a flattened lens assembly 808, according to some embodiments.

In some embodiments, the multi-beam antenna system 800 may include a multi-beam flat lens antenna array, shown in FIG. 8 by example as a flat lens assembly 808. For example, the flat lens assembly 808 may include a dielectric lens 809 having a first substantially planar surface 809a and a second substantially planar surface 809b opposite to the first surface. In the illustrated example, the first substantially planar surface 809a and the second substantially planar surface 809b are substantially parallel to one another. As described further herein, the dielectric lens 809 may have a distribution of effective dielectric constant such that a focal point 811 of the dielectric lens 809 is on the first planar surface 809a, which may facilitate locating antenna elements on the first planar surface 809a for a compact arrangement.

In some embodiments, the flat lens assembly 808 may further include an array of antenna elements 807 on the first planar surface 809a and configured to transmit and/or receive RF signals via the dielectric lens 809. For example, the antenna elements 807 may directly contact the first planar surface 809a. Alternatively, at least some material (e.g., dielectric matching material and/or insubstantial air gaps) may separate from the antenna elements 807 from the first planar surface 809a. In some embodiments, each antenna element 807 of the array may be configured to transmit and/or receive RF signals in a different respective direction via the dielectric lens 809. For example, the unique location of the antenna element 807 on the first planar surface 809a may cause transmitted and/or received RF signals to pass through a unique path through the dielectric lens 809 that focuses the transmit and/or RF signals in a corresponding direction, indicated by beams 810 in FIG. 8. It should be appreciated that beams may be formed using multiple antenna elements 807 simultaneously or using individual antenna elements 807 at a time, as the present disclosure is not so limited. The antenna elements 807 may include microstrip antennas, patch antennas, monopole antennas, and/or dipole antennas, but the present disclosure is not so limited.

In some embodiments, the flat lens assembly 808 may be configured to achieve wide scan angles over a wide bandwidth. For example, an antenna element 807 of the array (e.g., an edge element of the array) may be configured to transmit and/or receive RF signals in a first direction that is between 40 degrees and 60 degrees with respect to a central focal axis 812 of the dielectric lens 809, which may be perpendicular to the first planar surface 809a. For instance, the first direction may be between 40-45 degrees, 45-50 degrees, 50-55 degrees, and/or 55-60 degrees with respect to the central focal axis 812.

In some embodiments, the multi-beam antenna system 800 may further include circuitry coupled to the array of antenna elements 807 and configured to transmit and/or receive RF signals via the array of antenna elements 807 using the dielectric lens 809. For example, as shown in FIG. 8, the circuitry includes digital signal processing (DSP) circuitry 802, transmit and/or receive (T/R) circuitry 804, and antenna selection circuitry 806.

In some embodiments, the DSP circuitry 802 may be configured to control transmit and/or receive circuitry 804 and antenna selection circuitry 806 to transmit and/or receive RF signals via one or more selected antenna elements of the flattened lens assembly 808. For example, the DSP circuitry 802 may be configured as described herein for the control circuitry including in connection with FIG. 20. In some embodiments, the transmit and/or receive circuitry 804 may be configured as described herein for the transmit and receive circuitry including in connection with FIGS. 18-19. In some embodiments, the transmit and/or receive circuitry 804 may further include analog-to-digital conversion (ADC) and/or digital to analog conversion (DAC) circuitry configured to interface with the DSP circuitry 802.

In some embodiments, the antenna selection circuitry 806 may include a network (e.g., matrix) of RF switches coupled between the transmit and/or receive circuitry 804 and antenna elements 807 of the flattened lens assembly 808. For example, antenna selection circuitry 806 may be configured as an RF multiplexer, but the present disclosure is not so limited.

FIG. 8B is a front view of the dielectric lens 809 of the multi-beam antenna system 800 of FIG. 8A, according to some embodiments.

In some embodiments, locating the antenna elements 807 on the first planar surface 809a of the dielectric lens 809 is facilitated by having the focal point of the dielectric lens 809 lie on the first planar surface 809a. For example, the dielectric lens 809 may have a spatial distribution of effective dielectric constant configured to place the focal point of the dielectric lens 809 on the first planar surface.

In some embodiments, dielectric lens 809 may have an array of lens unit cells, shown in FIG. 8B as unit pixels 822, having dielectric material and conductive material. For example, an amount of the dielectric material and conductive material in each lens unit cell may be configured to produce an effective dielectric constant of the lens unit cell. For instance, the amount of dielectric material and conductive material in the lens unit cell may determine the extent of refraction and/or reflection of incident RF radiation, which in turn may replicate interaction with a dielectric material having a particular dielectric constant. In some embodiments, the effective dielectric constants of the array of lens unit cells are configured to collectively position the focal point of the dielectric lens 809 on the first planar surface 809a.

In some embodiments, the effective dielectric constants of the array of lens unit cells may be configured to produce less than a predetermined difference in effective dielectric constant between adjacent groups of lens unit cells of the array of lens unit cells. For example, gradual shifts in effective dielectric constant between lens unit cells or groups of lens unit cells may produce consistent focal properties of the dielectric lens 809 over a wide range of frequencies to obtain wideband performance. Thus, the predetermined difference in effective dielectric constant may depend on the extent of frequency bandwidth needed for a particular application.

### III. 3D Loaded Spiral Antenna

The present disclosure recognizes that spiral antennas offer large bandwidths and substantially radially symmetrical radiation patterns due to their substantially radially symmetrical geometry. A conventional spiral antenna has a pair of conductive spirals that wind in concentric circles around a center at which the spirals are fed, such as shown below. The total electrical length of the conductors as they spiral within a plane controls the lowest frequency of operation of the spiral antenna. However, the electrical length is limited by the physical length of the conductive spirals, which in turn is limited by the total area available for the spirals and the spacing between the spirals.

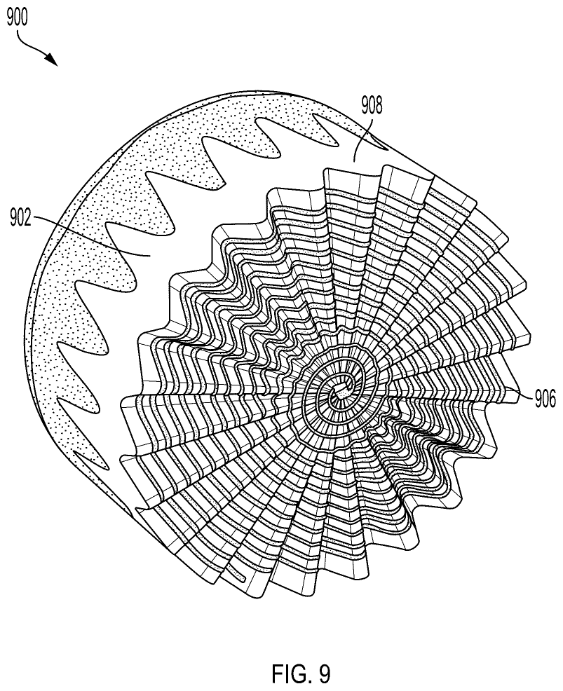

FIG. 9 is a perspective view of an example three-dimensional (3D) corrugated spiral antenna, according to some embodiments.

The present disclosure recognizes that the bandwidth of a spiral antenna may be extended within an available area by increasing the electrical length of the spiral antenna without significantly increasing the area or volume of the spiral antenna. One example spiral antenna 900 having extended bandwidth compared to a conventional spiral antenna includes meandering in a direction orthogonal to the plane in which the spiral conductors 906 wind around the feed. As shown in FIG. 9, the spiral conductors 906 may wind about the feed in the XY plane (e.g., top surface of the insulative cylinder 902) and the spiral conductors 906 may additionally meander in the Z direction orthogonal to the XY plane. In the example shown in FIG. 9, the top surface of the cylinder 902 on which the spiral conductors 906 are disposed has sinusoidal corrugations 908 running along the circumferential perimeter. The spiral conductors 906 thus have longer physical lengths than conventional spiral conductors that are contained within a two-dimensional plane.

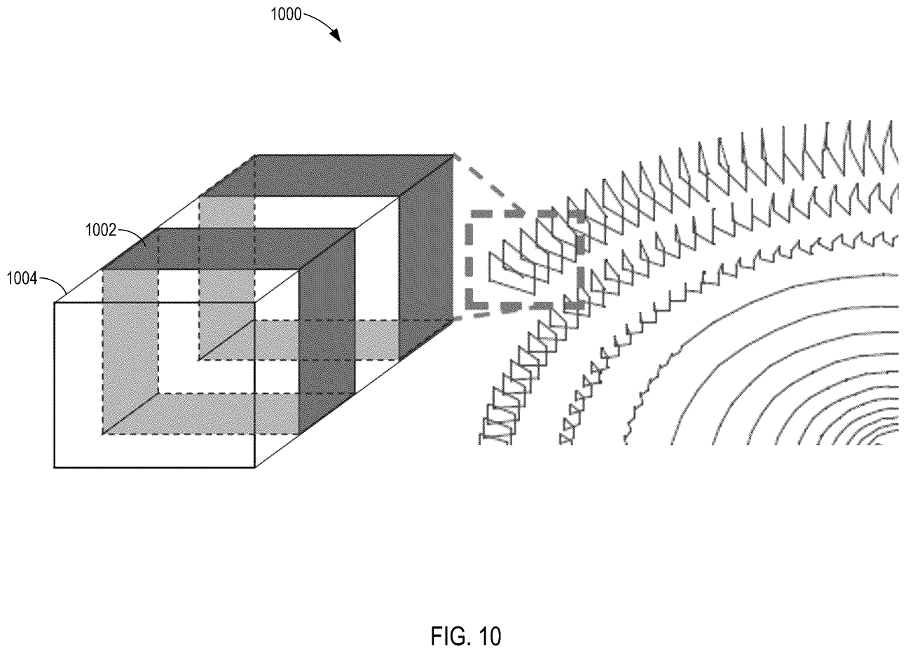

FIG. 10 is a perspective view of an example 3D helical spiral antenna 1000, according to some embodiments.

In another example, spiral conductors of a spiral antenna may meander orthogonally to the XY plane in a coil pattern such as shown in FIG. 10. For instance, a spiral antenna 1000 may have a dielectric substrate 1004 (e.g., PTFE) that spirals around a central feed in the XY plane, and the spiral conductors 1002 may wind around the dielectric substrate 1004 in the Z direction. In the example shown in FIG. 10, the radius of the windings increases with radial position within the spiral, but a constant radius of the coil pattern is also possible.

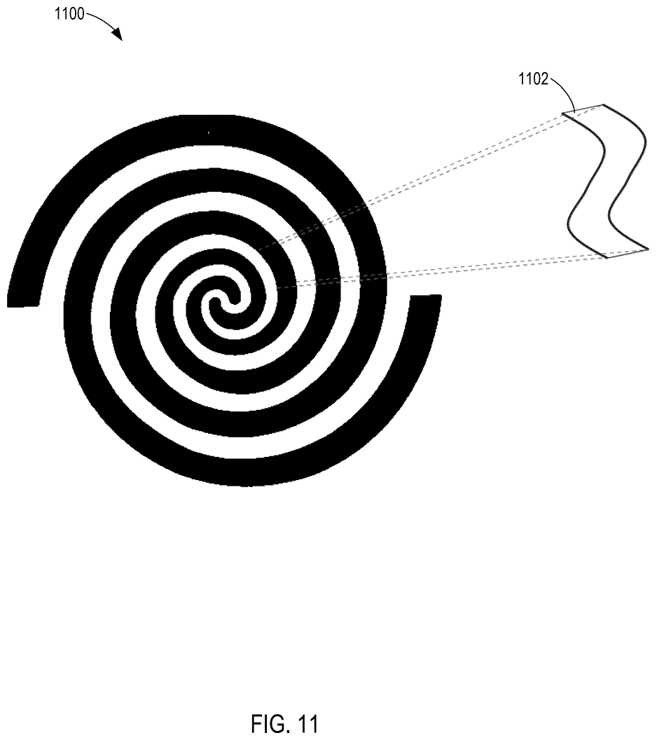

FIG. 11 is a top view of an example two-dimensional (2D) meandering spiral antenna 1100, according to some embodiments.

In yet another example, spiral conductors 1102 of a spiral antenna 1100 may meander within the XY plane and may further meander in the Z direction as shown in the previous examples. An example meandering pattern within the XY plane is shown in FIG. 11, which may be implemented together with the techniques used in the previous examples.

In yet another example, a capacitive loading element may be disposed above the spiral antenna. For instance, the capacitive loading element may include a dielectric superstrate, which increases the dielectric constant above the spiral conductors compared to air. By increasing the dielectric constant of the material in which the spiral conductors are disposed, the electrical lengths of the spiral conductors is increased without increasing their physical lengths. Alternatively or additionally, the capacitive loading element may include a conductive element, such as a conductive plate and/or additional spiral conductors spaced from the XY plane in the Z direction, which may be configured for capacitively coupling to the spiral conductors. Capacitively coupling the spiral conductors to an additional conductor may increase the electrical lengths of the spiral conductors without significantly increasing the volume of the antenna. It should be appreciated that capacitive loading may be used alone or in combination with techniques described above for extending physical lengths of the spiral conductors.

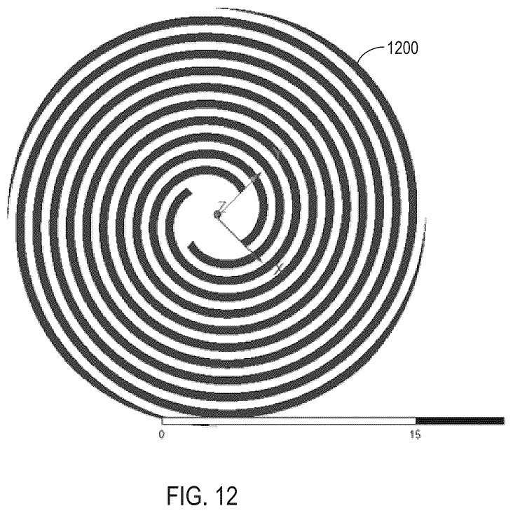

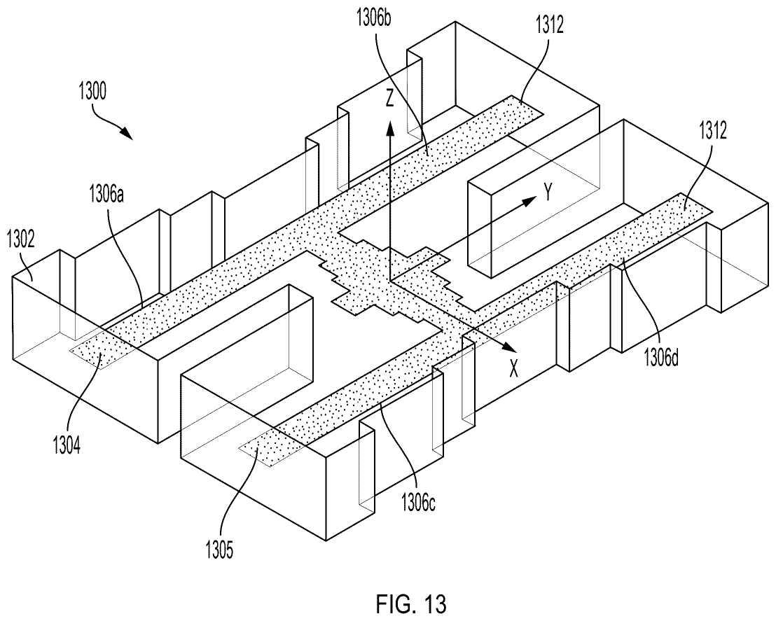

FIG. 12 is a top view of an example dual-polarized spiral antenna 1200, according to some embodiments.

In some embodiments, bandwidth-extension techniques described previously may be used in a dual-polarized configuration such as shown in FIG. 12 for a conventional spiral antenna. In this example, the spiral antenna includes four spiral conductors spiraled around two feeds, with a first feed (e.g., top left and bottom right in FIG. 12) providing a first polarization and a second feed (e.g., top right and bottom left in FIG. 12) providing a second polarization. Other polarizations may be achieved by applying a phase shift between the two feeds.

### IV. Suspended Stripline

The present disclosure recognizes that conventional transmission line structures are used at microwave to millimeter wave frequencies to propagate electrical signals with a controlled impedance. Conventional transmission lines are used in various configurations, such as quarter-wave impedance transformers, couplers (e.g., 90-degree hybrid coupler), and impedance matching circuits (e.g., shunt or series quarter-wave short-circuit or open circuit stubs). A common configuration of a transmission line structure is a microstrip transmission line in which a conductor is disposed on a dielectric substrate above a ground plane. Another type of transmission line is a stripline, in which a conductor is disposed between dielectric substrates that are in turn disposed between the conductor and respective ground planes.

The present disclosure recognizes that microstrip transmission lines have drawbacks in bandwidth and loss. First, microstrip transmission lines use transverse electric (TE) or transverse magnetic (TM) modes of propagation, which are limited in bandwidth by the cutoff frequency of the mode and by dispersion (e.g., different wave speeds over the bandwidth). Moreover, because a microstrip transmission line propagates electromagnetic waves in an underlying dielectric material, the waves are subject to losses. While a stripline can be implemented to take advantage of a transverse electromagnetic (TEM) mode that has larger bandwidth than TE or TM modes, a stripline includes more dielectric material than a microstrip and thus exhibits higher losses.

Accordingly, some embodiments provide a stripline having a very low dielectric constant, such as a dielectric constant close to that of air but not limited thereto. In some embodiments, a low dielectric constant may be achieved in a stripline structure by suspending the stripline conductor in a low dielectric material such as polystyrene or air. For example, the stripline may be mechanically supported at one or more locations by a strap or ring of a higher dielectric material at amounts small enough to have a minimal impact on the overall dielectric constant of the stripline. Example materials that may be used for supports include PTFE. The supports (e.g., straps or rings) may be suspended from a ground plane above and/or below the stripline. Advantages of stripline embodiments of the present disclosure include large bandwidth (e.g., using a TEM mode) and low dielectric loss.

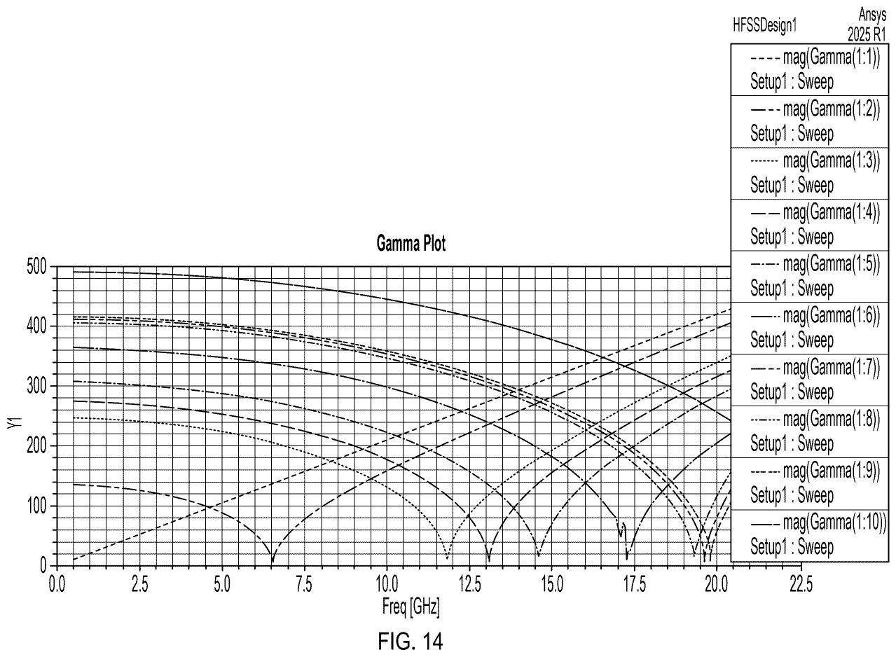

FIG. 13 a perspective view of an example 90-degree hybrid coupler 1300 implementing striplines, according to some embodiments. FIG. 14 is a Gamma chart for the hybrid coupler 1300 of FIG. 14, according to some embodiments.

As shown in FIG. 13, the coupler 1300 includes stripline sections coupled between an input port 1304, a coupled port 1305, and a pair of output ports 1312 (e.g., providing 0 degree and 90-degree phase-shifted outputs). Dielectric material 1302 such as air or low dielectric foam may surround the stripline sections. The stripline sections may be supported at 1306a, 1306b, 1306c, and 1306d to provide structural support without a significant impact on the overall dielectric constant of the stripline sections. Structures other than couplers implementing striplines are also envisioned within the scope of the present disclosure.

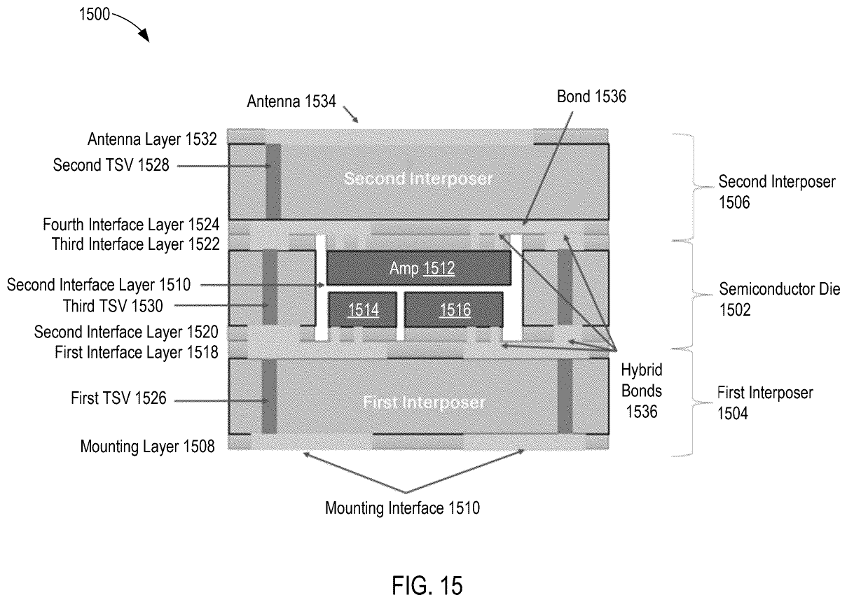

In some embodiments, stripline structures described herein may be implemented in a communications system-on-chip including an antenna. An example of such a system is shown in FIG. 15.

FIG. 15 is a side view of a cross section of a communications system-on-chip including an antenna and example stripline structures, according to some embodiments.

In the example shown in FIG. 15, an integrated circuit 1500 includes a semiconductor die 1502 packaged between interposer layers 1504 and 1506 (e.g., silicon interposers) that are hybrid-bonded to the semiconductor die 1502 via hybrid bonds 1536 on interface layers 1518, 1520, 1522, and 1524. The first interposer layer 1504 has a mounting interface 1510 on a mounting layer 1508 that may be configured for mounting to a substrate (e.g., printed circuit board). The semiconductor die 1502 has logic circuitry 1514, filters 1516, and an amplifier 1512. The second interposer layer 1506 has an antenna 1534 (e.g., a patch antenna) on an antenna layer 1532. The integrated circuit 1500 may be configured as a transmitter and/or a receiver. For example, as a transmitter, the circuitry on the semiconductor die 1502 may be configured to generate or obtain a signal using a first through-semiconductor-via (TSV) 1526 (e.g., from the printed circuit board), provide the signal to the antenna 1534 using a second TSV 1528, and transmit the signal via the antenna 1534. As a receiver, the circuitry on the semiconductor die 1502 may be configured to receive a signal via the antenna 1534 and condition the signal for outputting via the mounting interface 1510 (e.g., to the printed circuit board). Another TSV 1530 may be configured to bypass circuitry on the semiconductor die 1502, such as to couple to the amplifier 1512 on the upper portion of the semiconductor die 1502 from the interface layer 1522. In some embodiments, a stripline structure as described above may be useful in a communication system-on-chip configuration to implement at least some circuit structures with large bandwidth and low loss, but is not limited thereto.

### V. Constant Beam Feed Horn

A conventional horn antenna has a tapered body with a small aperture at a first end and a large aperture at a second end. The horn antenna is fed proximate the small aperture at the first end and propagates signals into and out of the large aperture at the second end. Wideband horn configurations have been achieved by including tapered conductive portions along the inner walls of the tapered body and feeding the horn between the tapered conductive portions.

The present disclosure recognizes that horn configurations can achieve large bandwidths, but the beamwidth produced by the horn over the operating bandwidth varies significantly, which can be problematic for some applications. The beamwidth produced by the horn at a given frequency depends largely on the aperture size at the location along the tapered body of the horn that resonates at the given frequency. Large aperture portions of the horn resonate at low frequencies, and thus achieve wide beamwidth at low frequencies. On the other hand, small aperture portions of the horn resonate at high frequencies and thus achieve narrow beamwidth at high frequencies.

According to some embodiments, a horn antenna may include a dielectric rod structure that improves beamwidth consistency over the bandwidth of the antenna. It is recognized that a dielectric rod occupying at least part of the horn antenna may alter the electrical sizes of aperture portions of the horn antenna. Superposition of the dielectric rod and the horn antenna (e.g., with phase centers of the dielectric rod and horn antenna substantially aligned) may counteract differences in aperture size along the horn at different frequencies, resulting in a substantially constant beamwidth over the bandwidth of the antenna.

In some embodiments, a first dielectric layer of the dielectric rod may be configured to counteract beamwidth of the horn with which the dielectric rod is implemented, and a second dielectric layer may be disposed between the first dielectric layer and the horn to provide an impedance match. For example, the first dielectric layer may have a dielectric constant selected based on the available area between conductive portions of the horn to provide an aperture having an electrical size that appropriately counteracts the beamwidth of the horn. The second dielectric layer may have a dielectric constant that provides a quarter-wave transformation between the horn and the first dielectric layer. In some embodiments, a polyethylene rod may be implemented as a dielectric rod.

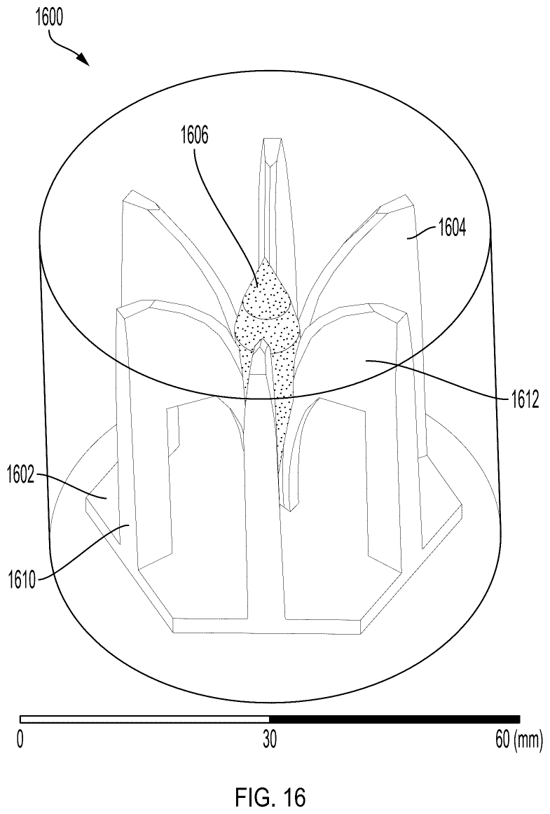

FIG. 16 is a perspective view of an example horn antenna 1600 with a dielectric rod 1606, according to some embodiments.

In the example shown in FIG. 16, the horn antenna 1600 is implemented with tapered conductive portions 1604, 1610, 1612 separated by a slot, which may be fed proximate the small end of the slot (e.g., the bottom plate 1602 of the illustrated structure, which may be configured as a ground plane). The dielectric rod 1606 is positioned in the slot between the tapered conductive portions 1604, 1610, 1612 and may have its phase center substantially aligned (e.g., along the axis of the slot) with the feed point along the slot.

The configuration of FIG. 16 includes Vivaldi-configured tapered conductive portions 1604, 1610, 1612 and does not include a tapered body around the conductive portions 1604, 1610, 1612, though other embodiments may include different conductive portion configurations and/or a tapered body around the conductive portions. Also, in the example shown in FIG. 16, the horn has three pairs of tapered conductive portions with aligned slots, which may be configured to provide multiple polarizations (e.g., dual-polarization), but other configurations (e.g., single-polarization, dual-horn pair) are possible.

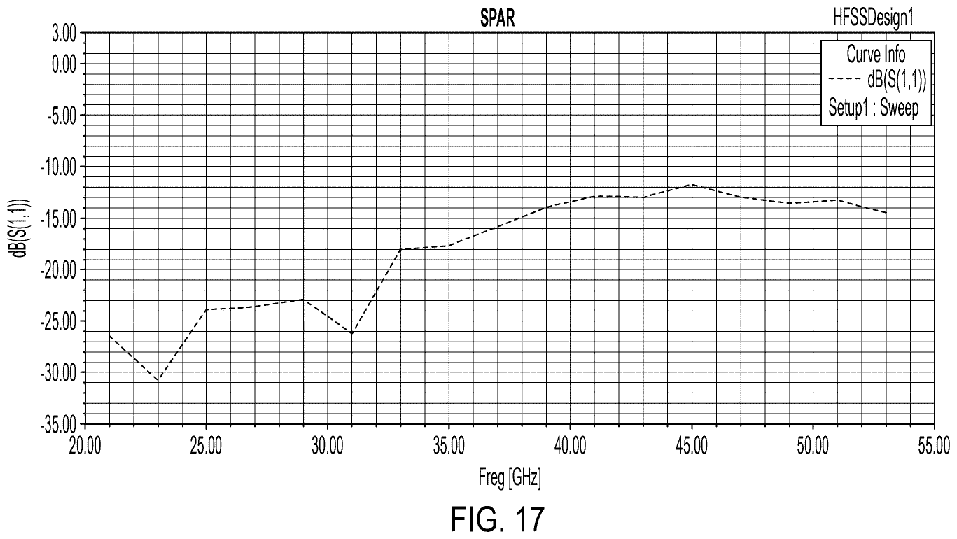

FIG. 17 is a graph of simulated return loss for the horn antenna of FIG. 16, according to some embodiments. The simulation results show return loss of less than −10 dB at least over a band from 21 GHz to 53 GHz.

### VI. Example Transmit, Receive, and Control Circuitry

FIG. 18 is a circuit diagram of example transmit circuitry 1800, which may be included in RF circuitry used with antennas described herein, according to some embodiments. FIG. 19 is a circuit diagram of example receive circuitry 1900, which may be included in RF circuitry used with antennas described herein, according to some embodiments.

In some embodiments, the transmit circuitry 1800 shown in FIG. 18 may be configured to obtain a signal (e.g., from control circuitry such as described in connection with FIG. 20) and provide a signal to an antenna for transmission. For example, in FIG. 18, the transmit circuitry 1800 includes signal generator logic 1802, an up-conversion modulator 1804, an RF filter 1806, and a transmit power amplifier (PA) 1808. For instance, the signal generator logic 1802 may be configured to generate a signal for transmitting via the antenna, the up-conversion modulator 1804 may be configured to up-convert the signal from the signal generator logic 1802 for providing to the antenna, the RF filter 1806 may be configured to pass the signal to the transmit PA 1808, and the transmit PA 1808 may be configured to provide the signal to the antenna.

In some embodiments, the signal generator logic 1802 may be configured to obtain a signal (e.g., from control circuitry) and provide a signal for transmission by an antenna. For example, the signal generator logic 1802 may be configured to obtain a clock signal, based on which the signal generator logic 1802 may be configured to generate and provide the signal for transmission by the antenna. In the same or another example, the signal generator logic 1802 may be configured to obtain a trigger signal, in response to which the signal generator logic 1802 may be configured to generate and provide the signal for transmission by the antenna. Alternatively or additionally, the signal generator logic 1802 may be omitted and/or configured to be bypassed such that the signal transmitted by the antenna is generated externally (e.g., by the control circuitry).

In some embodiments, the up-conversion modulator 1804 may be configured to obtain the signal generated by the signal generator logic 1802 and up-convert the signal to a frequency range of transmission by an antenna. For example, the up-conversion modulator 1804 may include a frequency multiplier and/or mixer. For instance, where the up-conversion modulator 1804 includes a mixer, the mixer may be configured to mix the signal with a local oscillator (LO) signal, which may be obtained from the signal generator logic 1802. It should be appreciated that the up-conversion modulator 1804 may be alternatively or additionally configured to obtain the signal and/or LO signal externally (e.g., from control circuitry), such as in embodiments that omit the signal generator logic 1802.

In some embodiments, the RF filter 1806 may be configured to pass the up-converted signal from the up-conversion modulator 1804 to an antenna. For example, the RF filter 1806 may be implemented as a band-pass filter having a passband aligned at least in part with the frequency range of transmission by the antenna. For instance, the RF filter 1806 may be configured to stop other frequencies, such as baseband, an IF band, and/or harmonics generated by the up-conversion modulator 1804 outside the frequency range of transmission by the antenna.

In some embodiments, the transmit PA 1808 may be configured to obtain the signal passed by the RF filter 1806 and provide the signal to an antenna. For example, the transmit PA 1808 may be configured to drive the antenna with RF energy in the frequency range of transmission by the antenna, such as over at least a portion of a frequency range at which the antenna is configured to transmit signals. In some embodiments, the transmit PA 1808 may be implemented with compound semiconductor materials, such as using gallium arsenide (GaAs) and/or gallium nitride (GaN) transistor technologies, though it should be appreciated that other semiconductor materials are possible.

In some embodiments, the receive circuitry 1900 shown in FIG. 19 may be configured to obtain a signal via an antenna and provide a signal externally (e.g., to control circuitry). For example, in FIG. 19, the receive circuitry 1900 includes an RF filter 1902, a receive low-noise amplifier (LNA) 1904, a down-conversion demodulator 1906, an IF and/or baseband filter 1908, and signal processing logic 1910. For instance, the RF filter 1902 may be configured to pass a signal from the antenna to the receive LNA 1904, the down-conversion demodulator 1906 may be configured to down-convert the signal from the antenna to an IF band and/or baseband, the IF and/or baseband filter 1908 may be configured to pass the down-converted signal from the down-conversion demodulator 1906 to the signal processing logic 1910, and the signal processing logic 1910 may be configured to process the signal and provide a signal externally (e.g., to control circuitry).

In some embodiments, the RF filter 1902 may be configured to obtain a signal from an antenna and provide the signal to the receive LNA 1904. For example, the RF filter 1902 may be implemented as a band-pass filter having a passband aligned at least in part with the frequency range of reception by the antenna. For instance, the RF filter 1902 may be configured to stop other frequencies, such as background noise outside the frequency range of reception by the antenna.

In some embodiments, the receive LNA 1904 may be configured to obtain the signal from the RF filter 1902 and provide the filtered signal to the down-conversion demodulator 1906. For example, the receive LNA 1904 may be configured to amplify RF energy in the signal in the frequency range of reception by an antenna, such as over at least a portion of a frequency range at which the antenna is configured to receive signals, to mitigate at least some noise that may be introduced by the down-conversion demodulator 1906. In some embodiments, the receive LNA 1904 may be implemented with compound semiconductor materials, such as using GaAs and/or GaN transistor technologies, though it should be appreciated that other semiconductor materials are possible.

In some embodiments, the down-conversion demodulator 1906 may be configured to obtain the conditioned signal from the receive LNA 1904 and down-convert the signal to an IF band and/or baseband, such as a band in which the signal processing logic 1910 may be configured to perform processing. For example, the down-conversion demodulator 1906 may include a frequency divider and/or mixer. For instance, where the down-conversion demodulator 1906 includes a mixer, the mixer may be configured to mix the signal with an LO signal, which may be obtained from the signal processing logic 1910. It should be appreciated that the down-conversion demodulator 1906 may be alternatively or additionally configured to obtain the LO signal externally (e.g., from control circuitry), and/or to down-convert the signal to an IF band and/or baseband in which external circuitry (e.g., control circuitry) is configured to perform processing, such as in embodiments that omit the signal processing logic 1910.

In some embodiments, the IF and/or baseband filter 1908 may be configured to pass the down-converted signal from the down-conversion demodulator 1906 to the signal processing logic 1910. For example, the IF and/or baseband filter 1908 may be implemented as a band-pass filter having a passband aligned at least in part with the IF band and/or baseband in which the signal processing logic 1910 is configured to perform processing. For instance, the IF band and/or baseband filter 1908 may be configured to stop other frequencies, such as the frequency range of reception by an antenna and/or harmonics generated by the down-conversion demodulator 1906 outside the frequency range of reception by the antenna.

In some embodiments, the signal processing logic 1910 may be configured to obtain the down-converted signal via the IF and/or baseband filter 1908, process the signal, and provide a signal externally (e.g., to control circuitry). For example, the signal processing logic 1910 may be configured to extract information encoded in the down-converted signal, such as a message (e.g., in an information communication system) and/or an indication of a detected object (e.g., in a detection communication system). Alternatively or additionally, the signal processing logic 1910 may be omitted and/or configured to be bypassed such that the signal received by an antenna is processed externally (e.g., by control circuitry).

In some embodiments, the signal generator logic 1802 and/or signal processing logic 1910 may include an FPGA, an ASIC, and/or a microcontroller. While not shown in FIGS. 18-19, some embodiments may alternatively or additionally include data conversion circuitry, such as including ADC circuitry and/or DAC circuitry. For example, ADC circuitry may be coupled between components of the receive circuitry 1900 (e.g., the LNA) and the signal processing logic 1910 (e.g., implemented using digital processing circuitry), and/or DAC circuitry may be coupled between the signal generator logic 1802 (e.g., implemented using digital processing circuitry) and components of the transmit circuitry 1800 (e.g., the PA).

In some embodiments, the transmit circuitry 1800 and/or receive circuitry 1900 may alternatively or additionally include one or more switches, such as RF switches, IF switches, and/or baseband switches. For example, switches may be implemented to select a transmit and/or receive path (e.g., antenna) for transmission and/or reception (e.g., in a multiple antenna element configuration), and/or to select between a transmit path and a receive path to and/or from an antenna (e.g., in a transceiver configuration). In some embodiments, switches may be implemented using metal oxide semiconductor field effect transistor (MOSFET), GaN, and/or GaAs technology, though other configurations are possible.

In some embodiments, the transmit circuitry 1800 and/or receive circuitry 1900 may alternatively or additionally include one or more power control components, such as automatic gain control (AGC) circuitry (e.g., coupled to the PA and/or LNA) and/or a power limiter (e.g., RF limiter coupled to the LNA and/or PA).

FIG. 20 is a block diagram of an example computer system 2100 that may be configured to perform at least some operations described herein in connection with FIGS. 1-19, according to some embodiments. For example, computer system 2100 may be configured to implement control circuitry as described herein.

An illustrative implementation of a computer system 2100 that may be used in connection with any of the embodiments of the disclosure provided herein is shown in FIG. 20. For example, in some embodiments, operations described herein including in connection with control circuitry may be performed using the computer system 2100. The computer system 2100 may include one or more processors 2102 and one or more articles of manufacture that comprise non-transitory computer-readable storage media (e.g., memory 2104 and one or more non-volatile storage media 2106). The processor 2102 may control writing data to and reading data from the memory 2104 and the non-volatile storage device 2106 in any suitable manner, as the aspects of the disclosure provided herein are not limited in this respect. To perform any of the functionality described herein, the processor 2102 may execute one or more processor-executable instructions stored in one or more non-transitory computer-readable storage media (e.g., the memory 2104), which may serve as non-transitory computer-readable storage media storing processor-executable instructions for execution by the processor 2102.

In some embodiments, control circuitry may be alternatively or additionally implemented in digital logic circuitry, such as field programmable gate arrays (FPGAs) and/or application-specific integrated circuits (ASICs).

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only and is not intended as limiting. The techniques are limited only as defined by the following claims and the equivalents thereto.

1.-20. (canceled)

21. A multi-beam flat lens antenna array, comprising:
a dielectric lens having a first substantially planar surface and a second substantially planar surface opposite to the first surface; and
an array of antenna elements on the first planar surface and configured to transmit and/or receive radio-frequency (RF) signals via the dielectric lens.

22. The multi-beam flat lens antenna array of claim 21, wherein each antenna element of the array of antenna elements is configured to transmit and/or receive RF signals in a different respective direction via the dielectric lens.

23. The multi-beam flat lens antenna array of claim 22, wherein the array of antenna elements comprises a first antenna element configured to transmit and/or receive RF signals in a first direction of the different respective direction via the dielectric lens, wherein the first direction is between 40 degrees and 60 degrees with respect to a central focal axis of the dielectric lens.

24. The multi-beam flat lens antenna array of claim 21, further comprising:
circuitry coupled to the array of antenna elements and configured to transmit and/or receive RF signals via the array of antenna elements using the dielectric lens.

25. The multi-beam flat lens antenna array of claim 21, further comprising antenna selection circuitry configured to select antenna elements of the array of antenna elements to transmit and/or receive the RF signals via the dielectric lens.

26. The multi-beam flat lens antenna array of claim 21, wherein the dielectric lens has a distribution of effective dielectric constant such that a focal point of the dielectric lens is on the first planar surface.

27. The multi-beam flat lens antenna array of claim 26, wherein the dielectric lens comprises an array of lens unit cells having dielectric material and conductive material, wherein an amount of the dielectric material and conductive material in each lens unit cells is configured to produce an effective dielectric constant of the lens unit cell, and wherein the effective dielectric constants of the array of lens unit cells are configured to position the focal point of the dielectric lens on the first planar surface.

28. The multi-beam flat lens antenna of claim 27, wherein the effective dielectric constants of the array of lens unit cells are configured to produce less than a predetermined difference in effective dielectric constant between adjacent groups of lens unit cells of the array of lens unit cells.
